(19) United States
(12) Patent Application Publication
(10) Pub. No.: US 2011/0163213 A1
(43) Pub. Date: Jul. 7, 2011

(54) MAILBOX MOUNTING SYSTEM

(76) Inventor: Jeffery Borowiak, Gaylord, MI (US)

(21) Appl. No.: 12/984,971

(22) Filed: Jan. 5, 2011

Related U.S. Application Data
(60) Provisional application No. 61/292,247, filed on Jan. 5, 2010.

(51) Int. Cl. F16M 13/02

(52) U.S. Cl. 248/219.2

(57) ABSTRACT

A system mounts a mailbox to an upstanding post defining an upper portion of the post. The system includes a plate adapted to mount the mailbox and defining a lower surface and an upper surface of the plate, the upper surface being adapted to support a lower surface of the mailbox. A sleeve extends downwardly from the lower surface of the plate, is adapted to matingly receive the upper portion of the post, and defines at least one interior wall of the sleeve. The interior wall defines at least one rib of the interior wall adapted to contact an exterior surface of the upper portion to fittingly secure the post within the sleeve and, thus, mount the mailbox to the post. Alternatively, the sleeve is adapted to be matingly received by the upper portion of the post. Alternatively, multiple mailboxes can be supported by a single system.

### CROSS-REFERENCE TO RELATED APPLICATION

This application claims priority to and benefit of the filing date of U.S. Provisional Patent Application 61/292,247 filed on Jan. 5, 2010 and entitled “Mailbox Mounting System.”

### BACKGROUND OF INVENTION

1. Field of Invention

The invention relates, generally, to a mailbox and, more particularly, to a system for mounting the mailbox to a post.

2. Description of Related Art

Mailboxes are often supported on an upstanding post and disposed adjacent a roadway at a specific height as directed by the U.S. Postal Service. The mailboxes are usually fixedly mounted to the post via fasteners—such as bolts, nails, screws, brackets, and/or the like. Because of proximity to the roadway, mailboxes can be subject to damage from many sources. For example, mailboxes can be struck by automobiles or other moving objects and subject to vandalization. In climates that receive significant snowfall, mailboxes can be damaged by snow thrown from plows servicing the roadway. Beyond these examples, other things can impact and, therefore, damage a typical mailbox system. Yet, mailboxes are not meant to be abused in this way. Because they are generally rigidly mounted to a support structure, mailboxes can frequently become damaged and need to be replaced. And, because they typically form a unitary, rigid system, both the mailbox and its associated support structure typically suffer damage at the same time.

Accordingly, in certain climates and under certain circumstances, it may be desirable to remove the mailbox from its standard “roadside” position for preservation or security reasons. This may become desirable after a significant snowfall and in anticipation of plowing of the roadway. Alternatively, it may be desirable to move the mailbox when the homeowner is on vacation or for security or any other reason as may, from time to time, present itself Unfortunately, the mailbox systems commonly employed in the related art are generally not moveable, but fixedly mounted to the support structure.

Thus, there is a need in the related art for a mailbox system a mailbox of which is firmly supported on a support structure, but that can be quickly and easily detached from the support structure when this is desired. In addition, there is a need in the related art for a mailbox system the mailbox of which may be quickly and easily reattached to the support structure without need of fasteners—such as bolts, screws, and/or nails of the type commonly employed in the related art.

### SUMMARY OF INVENTION

The invention overcomes the disadvantages in the related art in a system for mounting a mailbox to an upstanding post defining a closed-ended upper portion of the post. The system includes a plate adapted to mount the mailbox and defining a lower surface and an upper surface of the plate, the upper surface being adapted to support a lower surface of the mailbox. A sleeve extends downwardly from the lower surface of the plate, is adapted to matingly receive the upper portion of the post, and defines at least one interior wall of the sleeve. The interior wall defines at least one rib adapted to contact an exterior surface of the upper portion of the post to fittingly secure the post within the sleeve and, thus, mount the mailbox to the post.

Alternatively, the post defines an open-ended upper portion of the post, and the sleeve is adapted to be matingly received by the upper portion of the post. To this end, the sleeve defines at least one exterior wall of the sleeve. The exterior wall defines at least one rib of the exterior wall adapted to contact an interior surface of the upper portion of the post to fittingly secure the sleeve within the post and, thus, mount the mailbox to the post.

Alternatively, the system includes further a support member attached to the plate and adapted to support the lower surface of the mailbox such that the mailbox extends substantially transversely with respect to the plate. In this way, a sufficient amount of space is defined to at least one side of the mailbox for at least another mailbox to be supported by the plate.

The mailbox-mounting system of the invention can be used to conveniently, easily, efficiently, and safely install the mailbox to the post. Also, use of the system eliminates a need for any fasteners—such as bolts, brackets, nuts, and/or screws—or tools to install the mailbox to the post. And, use of the system can eliminate damage and, thus, a need to make any repairs to the mailbox. More specifically, the system can be easily and quickly removed from the post when there is sufficient notice of impending natural occurrences—such as fire and/or heavy ice, rain, snow, and/or wind—that could damage the mailbox. Furthermore, in the event that the mailbox needs to be repaired, the system eliminates repairing of the mailbox in or adjacent to vehicular traffic. More specifically, the system allows for repair of the mailbox in a safe environment, such as inside a garage or house. In addition, the system can be used with an existing post and even if a new post is needed. Moreover, the system is one-piece. Plus, the system 10 can be easily used by the general population. A single system can install multiple mailboxes to the post as well.

Other objects, features, and advantages of the mailbox-mounting system of the invention will be readily appreciated as the system becomes more understood while the subsequent detailed description of an embodiment of the system is read taken in conjunction with the accompanying drawing of such embodiment.

### BRIEF DESCRIPTION OF EACH FIGURE OF DRAWING

FIG. 1 is an environmental perspective view of an embodiment of the mailbox mounting system of the invention illustrating the post fittingly secured within the sleeve and, thus, the mailbox mounted to the post.

FIG. 2 is an environmental perspective assembly view of the embodiment of the mailbox-mounting system of the invention shown in FIG. 1 illustrating use of the system to mount the mailbox to the post.

FIG. 3 is an end view of the embodiment of the mailbox-mounting system of the invention shown in FIG. 1.

FIG. 4 is a side view of the embodiment of the mailbox-mounting system of the invention shown in FIG. 1.

FIG. 5 is a bottom view of the embodiment of the mailbox-mounting system of the invention shown in FIG. 1.

FIG. 6 is a bottom perspective view of the embodiment of the mailbox-mounting system of the invention shown in FIG. 1.

FIG. 7 is an exploded bottom perspective view of the embodiment of the mailbox-mounting system of the invention shown in FIG. 1 illustrating the sleeve thereof.

FIG. 8 is an environmental perspective assembly view of another embodiment of the mailbox-mounting system of the invention illustrating use of the system to fittingly secure the sleeve within the post.

FIG. 9 is an environmental perspective assembly view of another embodiment of the mailbox-mounting system of the invention illustrating use of the system to optionally mount multiple mailboxes to the post.

### DETAILED DESCRIPTION OF EMBODIMENTS OF INVENTION

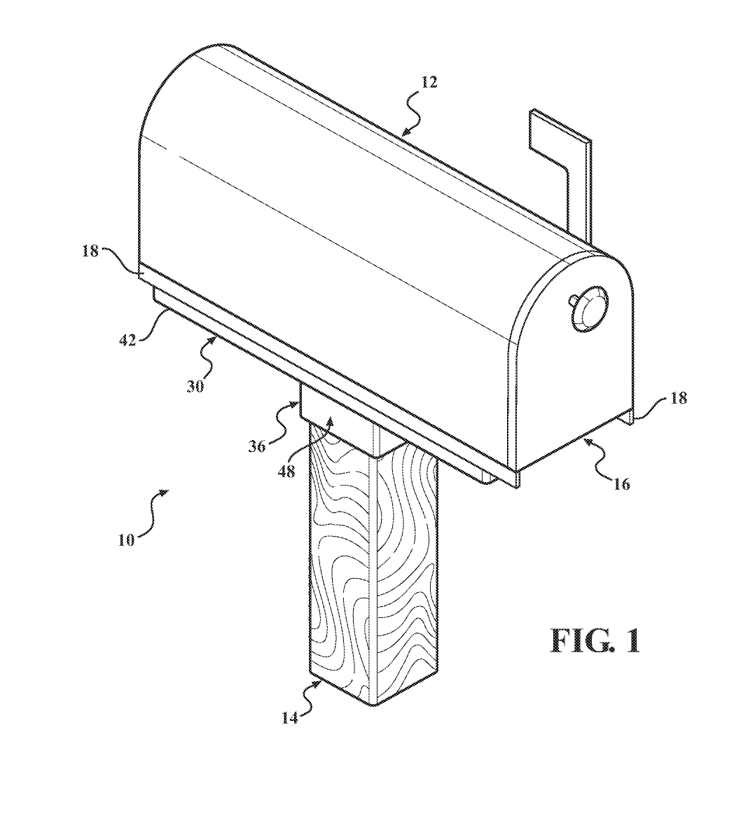

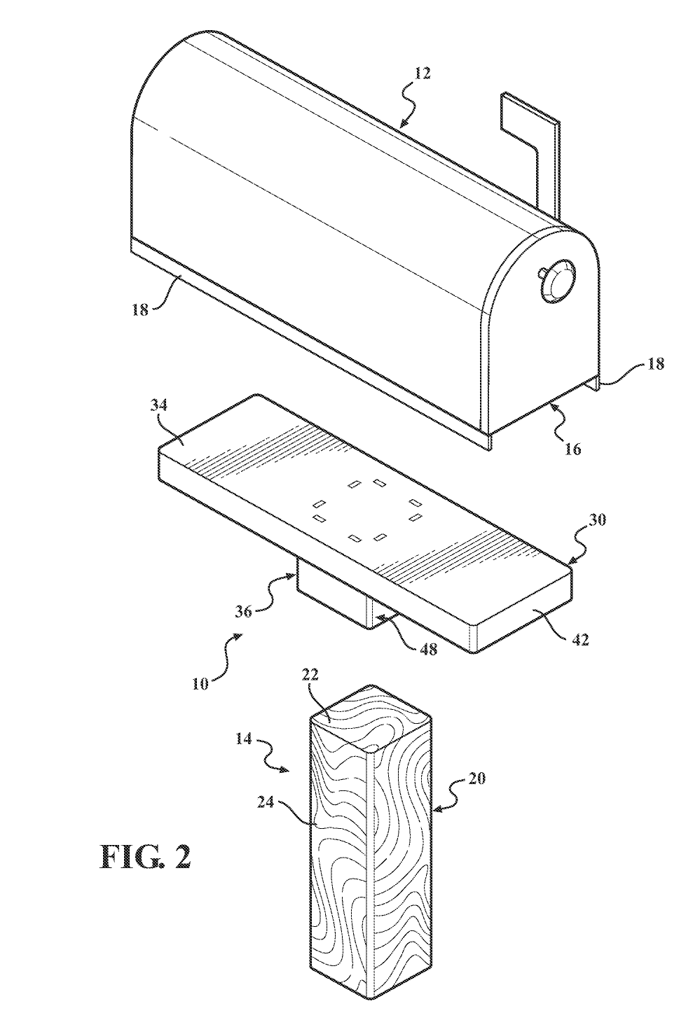

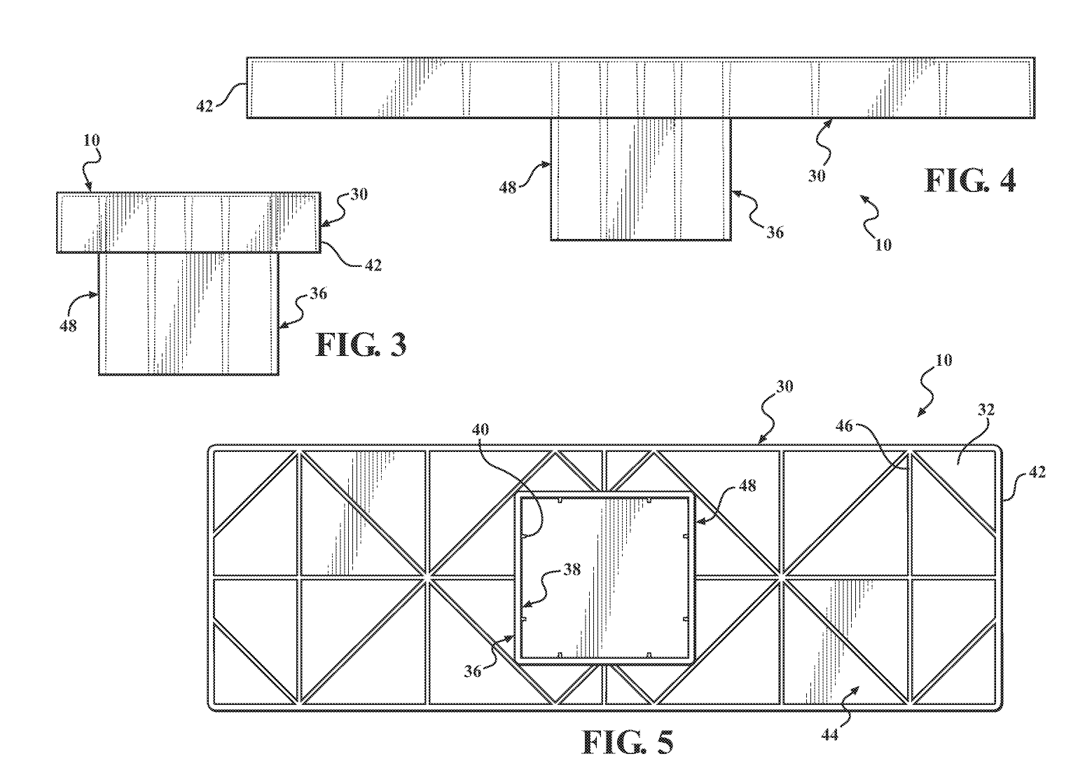

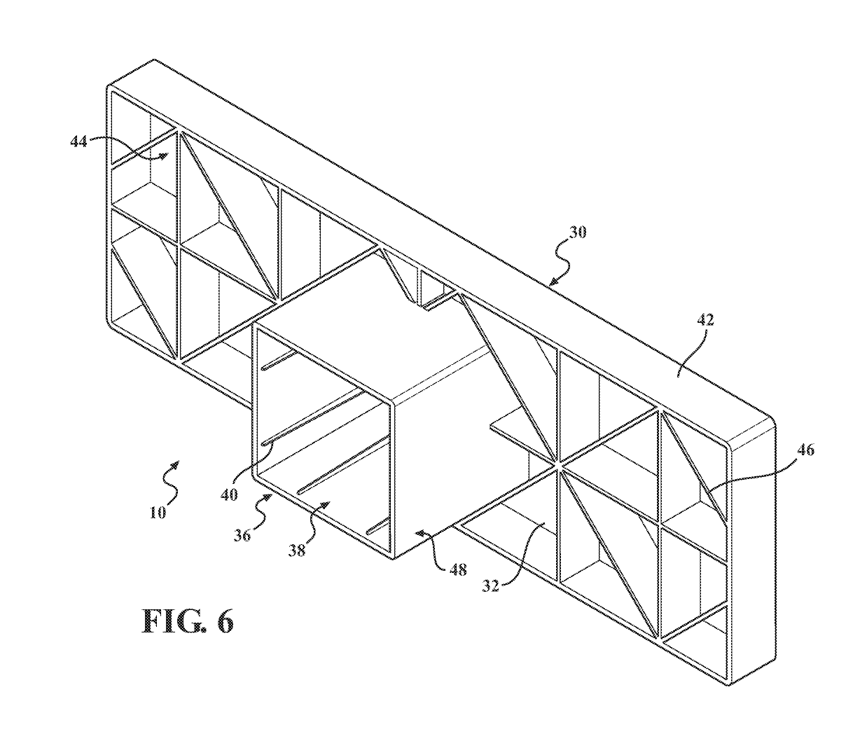

A mailbox mounting system according to the invention is generally indicated at 10 in FIGS. 1 through 7, where like numerals are used to designate like structure throughout the embodiments of the system 10 disclosed herein. Although the system 10 is described and shown herein employed with an upstanding post (such as a “4×4”), generally indicated at 14 in FIGS. 1 and 2, those having ordinary skill in the related art should appreciate that the system 10 can be employed with any suitable support for a mailbox, in general, and post, in particular.

Now with reference particularly to FIGS. 1 and 2, a mailbox 12 defines, among other things not necessarily relevant to employment of the system 10 with the mailbox 12, a lower surface, generally indicated at 16. The lower surface 16 is substantially planar and defines a substantially rectangular horizontal cross-section of the lower surface 16. The mailbox 12 also includes a pair of substantially identical flanges 18 that depend slightly from the lower surface 16 of the mailbox 12 and extend spaced from and substantially parallel with each other along an entirety of respective opposite sides of the lower surface 16. The flanges 18, in combination with the lower surface 16, define a volume of space that, as described in detail below, is adapted to receive a part of the system 10 to mount the system 10 to the mailbox 12.

It should be appreciated by those having ordinary skill in the related art that the mailbox 12, in general, and lower surface 16 and flanges 18 of the mailbox 12, in particular, can have any suitable design, shape, size, and structure and structural relationship with the system 10 and post 14. It should be so appreciated also that the volume of space of the mailbox 12 can have any suitable shape and size and relationship with the system 10 and post 14. It should be so appreciated also that the lower surface 16, flanges 18, and volume of space can have any suitable relationship with each other. From the description that follows, it should be so appreciated also that the mailbox 12 per se forms no part of the system 10.

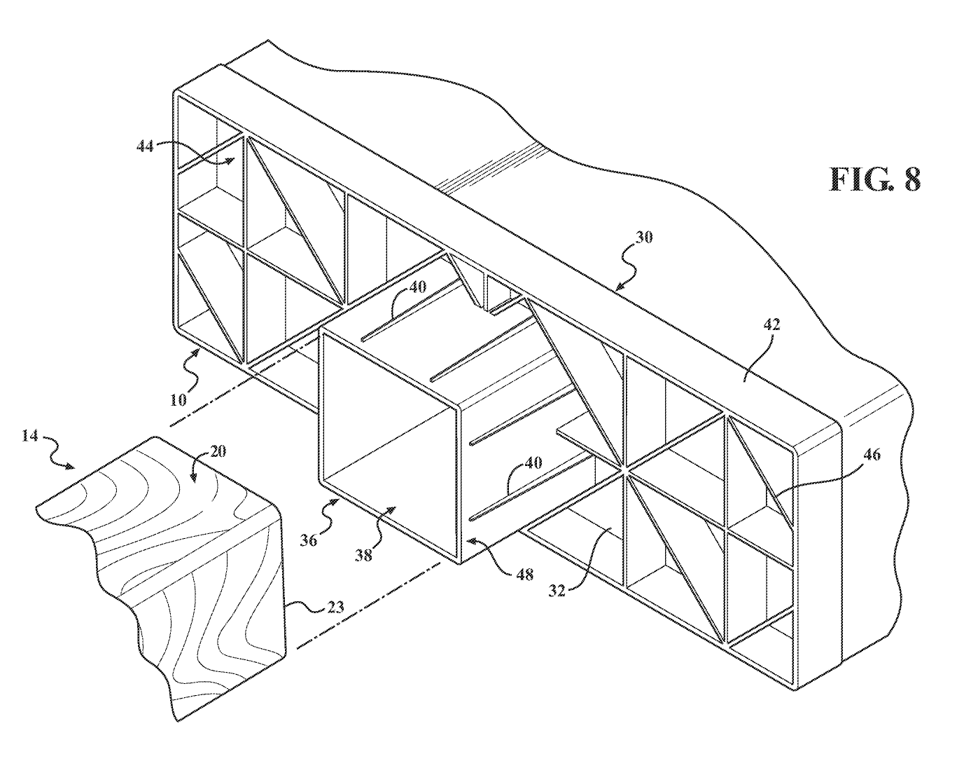

With reference particularly to FIG. 2, the post 14 defines, among other things not necessarily relevant to employment of the system 10 with the post 14, an upper portion, generally indicated at 20. In turn, the upper portion 20 of the post 14 defines a closed end 22 and an exterior surface 24. The upper portion 20 is typically solid and substantially cubical. Alternatively and as described in detail below with reference to FIG. 8, the upper portion 20 can define an open end 23 having an interior surface (not shown).

It should be appreciated by those having ordinary skill in the related art that the post 14, in general, and the upper portion 20, closed end 22, exterior surface 24, and interior surface of the post 14, in particular, can have any suitable shape, size, and structure and structural relationship with the system 10 and mailbox 12. It should be so appreciated also that the open end 23 of the post 14 can have any suitable shape and size and relationship with the system 10 and mailbox 12. It should be so appreciated also that the upper portion 20, closed end 22, open end 23, exterior surface 24, and interior surface of the post 14 can have any suitable relationship with each other. It should be so appreciated also that the post 14 per se forms no part of the system 10.

With reference to the figures and assuming that the upper portion 20 of the post 14 defines a closed end 22 and an exterior surface 24 of the upper portion 20, the system 10 includes, in general, a plate, generally indicated at 30, adapted to mount the mailbox 12. The plate 30 also defines a lower surface 32 (FIGS. 5 through 7) and an upper surface 34 (FIG. 2) of the plate 30, the upper surface 34 being adapted to support the lower surface 16 of the mailbox 12. A sleeve, generally indicated at 36, extends downwardly from the lower surface 32 of the plate 30. The sleeve 36 is adapted to matingly receive the upper portion 20 of the post 14 and defines at least one interior wall, generally indicated at 38 in FIGS. 5 through 7, and at least one exterior wall, generally indicated at 48. The interior wall 38 defines at least one rib 40 (FIGS. 5 through 7) that is adapted to contact the exterior surface 24 of the upper portion 20 of the post 14 to fittingly secure the post 14 within the sleeve 36 and, thus, mount the mailbox 12 to the post 14.

More specifically, in an embodiment of the system 10 and as shown in the figures, each of the lower and upper surfaces 32, 34, respectively, of the plate 30 is substantially planar, and the plate 30 defines a substantially rectangular slab of material. The upper surface 34 of the plate 30 is substantially coplanar with the lower surface 16 of the mailbox 12 such that the upper surface 34 and lower surface 16 are substantially flush with each other when the upper surface 34 comes into contact with the lower surface 16 to support the mailbox 12.

The plate 30 defines also a rim 42 that depends from and at least partially outlines the lower surface 32 of the plate 30. In the embodiment shown, the rim 42 is substantially uniform and disposed substantially perpendicular to each of the lower and upper surfaces 32, 34 of the plate 30. The rim 42 also integrally depends from and completely outlines the lower surface 32 of the plate 30. Also, each side and end of the rim 42 is substantially planar, and each corner of the rim 42 is arcuate.

In combination with the lower surface 32 of the plate 30, the rim 42 defines an interior, generally indicated at 44 in FIGS. 5 through 7, of the plate 30 in which an array of a plurality of ribs 46 (FIGS. 5 through 7) is disposed. The interior 44 defines a substantially rectangular horizontal cross-section and a depth of the interior 44 that is shallow relative to a width and length defined by the interior 44. Respective portions of the array (of the ribs 46) are attached to the rim 42, sleeve 36, and lower surface 32 of the plate 30 to provide structural integrity to the system 10. More specifically, each rib 46 is substantially planar and defines a substantially rectangular lengthwise cross-section. Each rib 46 also extends integrally from and substantially perpendicular to the lower surface 32 of the plate 30. The ribs 46 are substantially identical with each other, and each end of a rib 46 is in abutting contact with an end of another rib 46 or ends of other respective ribs 46, an interior surface of the rim 42, and/or the exterior wall(s) 48 of the sleeve 36. The rim 42 defines a bottom edge of the rim 42 that is disposed substantially flush with respect to a bottom edge defined by the array (of the ribs 46).

Except for the presence of the sleeve 36, the shape of the array (of the ribs 46) consists of essentially a series of hollow diamonds running the entire length of the interior 44, wherein diamonds disposed adjacent to each other meet at a point defined by corresponding vertices of the diamonds. A segment connects with each other each pair of vertices of each diamond disposed opposite each other, and a segment extends completely across the interior 44 between diamonds disposed adjacent to each other. In this way, the segments extending across the interior 44 are disposed substantially parallel with each other, perpendicular to the segment(s) extending along the interior 44, and at forty-five degrees with respect to each segment of each diamond. Pockets of space fill the remainder of the interior 44 (except for the presence of the sleeve 36).

A portion of the mailbox 12 is adapted to interferingly fit about at least a portion of the rim 42 of the plate 30 to mount the plate 30 to the mailbox 12. More specifically, an interior side of each flange 18 of the mailbox 12 is adapted to frictionally engage a corresponding side of the rim 42 of the plate 30 to mount the plate 30 to the mailbox 12. The plate 30 defines a length and width of the plate 30 that are greater than a corresponding length and width defined by the sleeve 36, and the plate 30 defines a height of the plate 30 that is lesser than a height defined by the sleeve 36. In addition, each flange 18 may include at least one aperture adapted to accept a corresponding fastener that may be used to mount the mailbox 12 to the plate 30 via the rim 42.

It should be appreciated by those having ordinary skill in the related art that the plate 30, in general, and each of the lower and upper surfaces 32, 34, rim 42, and ribs 46 of the array (of the ribs 46) of the plate 30, in particular, can have any suitable shape, size, and structure and structural relationship with the sleeve 36. It should be so appreciated also that the interior 44 of the plate 30 can have any suitable shape and size and relationship with the sleeve 36. It should be so appreciated also that the lower and upper surfaces 32, 34, rim 42, interior 44, and ribs 46 of the array (of the ribs 46) of the plate 30 can have any suitable relationship with each other. It should be so appreciated also that each of the sides, ends, corners, and bottom edge of the rim 42 can have any suitable shape, size, and structure and structural relationship with the remainder of the plate 30 and each other.

The sleeve 36 integrally extends downwardly from a substantially central portion of the lower surface 32 of the plate 30. The sleeve 36 defines a substantially square horizontal cross-section, an open free end, a hollow interior, and arcuate outside corners of the sleeve 36. In the embodiment shown, the sleeve 36 defines four interior walls 38 that are substantially planar and identical with respect to each other and four exterior walls 48 that are substantially planar and identical with respect to each other.

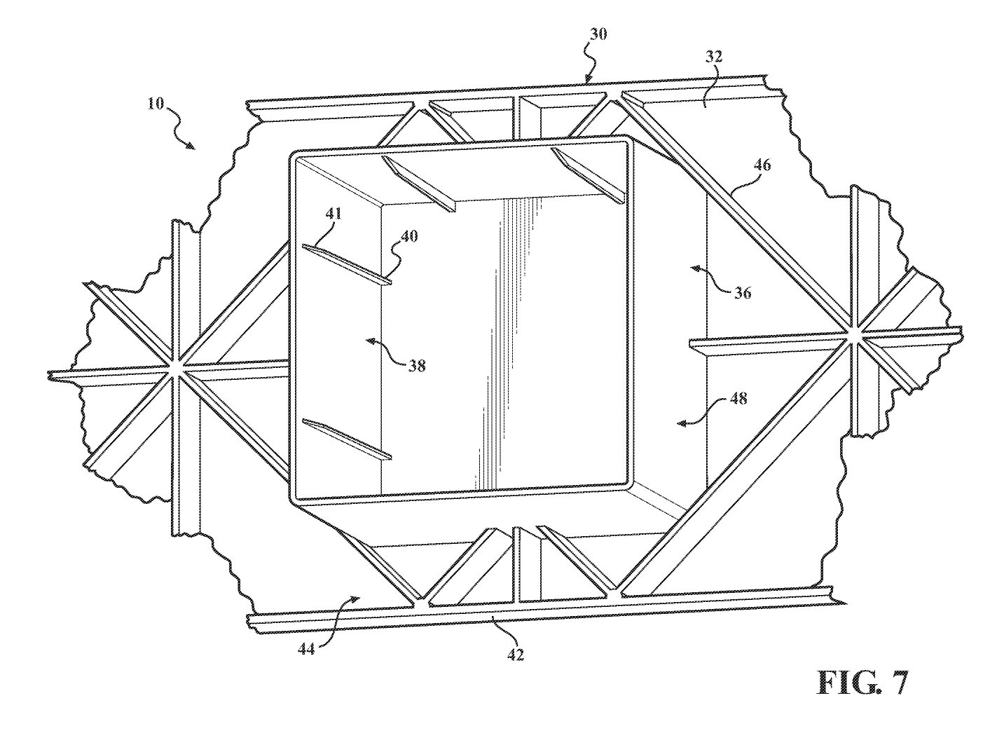

The rib 40 of each interior wall 38 of the sleeve 36 extends a substantial distance along the interior wall 38. More specifically, each interior wall 38 defines a plurality of ribs 40 of the interior wall 38 adapted to contact the exterior surface 24 of the upper portion 20 of the post 14 to fittingly secure the post 14 within the sleeve 36. Each rib 40 is spaced from any other rib 40 disposed adjacent to it and the corresponding side of the interior wall 38. A terminal end of each rib 40 (located distal the plate 30) includes a chamfered or tapered portion 41 (FIG. 7) that serves as the leading edge that engages the exterior surface 24 of the upper portion 20 of the post 14. The ribs 40 are substantially identical and disposed substantially parallel with respect to each other and extend substantially the entire length of the interior wall 38.

With reference particularly to FIG. 8, in another embodiment of the system 10 and assuming that the upper portion 20 of the post 14 defines the open end 23 and the interior surface of the upper portion 20, the sleeve 36 can be adapted to be matingly received in the upper portion 20 of the post 14. To this end, the exterior wall(s) 48 of the sleeve 36 can define the rib(s) 40, which can be adapted to contact the interior surface of the upper portion 20 of the post 14 to fittingly secure the sleeve 36 within the post 14 and, thus, mount the mailbox 12 to the post 14 in the same way as described above.

It should be appreciated by those having ordinary skill in the related art that the sleeve 36, in general, and each of the interior wall(s) 38, rib(s) 40, chamfered or tapered portion(s) 41, exterior wall(s) 48, and corner(s) of the sleeve 36, in particular, can have any suitable shape, size, and structure and structural relationship with the plate 30. It should be so appreciated also that the open free end and hollow interior of the sleeve 36 can have any suitable shape and size and relationship with the plate 30. It should be so appreciated also that the interior wall(s) 38, rib(s) 40, chamfered or tapered portion(s) 41, exterior wall(s) 48, corner(s), open free end, and hollow interior of the sleeve 36 can have any suitable relationship with each other.

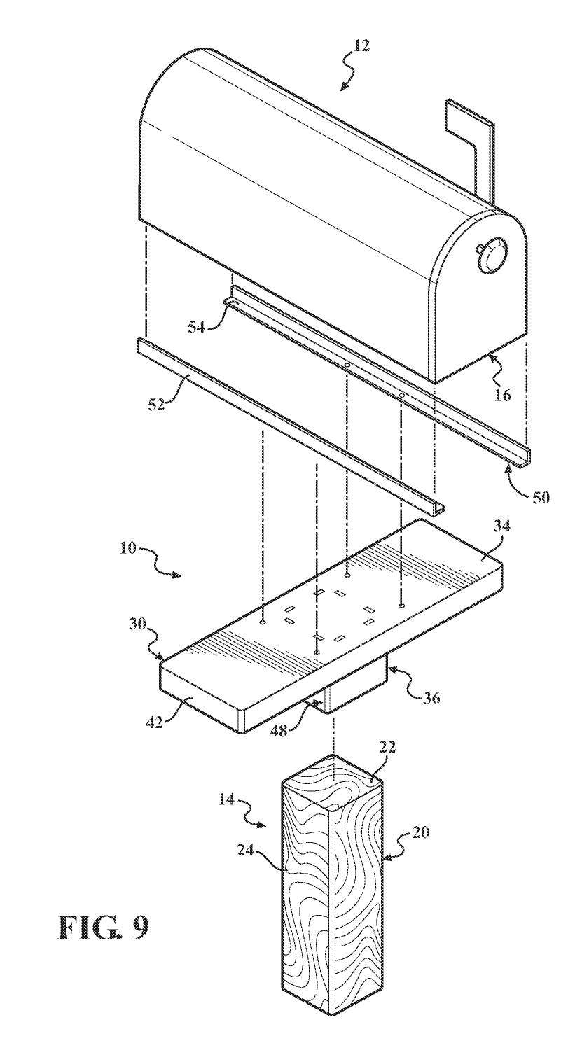

With reference particularly to FIG. 9, in another embodiment of the system 10, the system 10 is adapted to mount multiple mailboxes 12 to the post 14. To this end, a support member, generally indicated at 50, is attached to the plate 30 and extends across the upper surface 34 of the plate 30. The support member 50 is also adapted to support the lower surface 16 of the mailbox 12 and be fastened to the mailbox 12 such that the mailbox 12 extends substantially transversely with respect to the plate 30. In this way, a sufficient amount of space is defined to at least one side (either side or both sides) of the mailbox 12 for at least another mailbox (not shown) to be supported by the upper surface 34 of the plate 30 and mounted to the plate 30 (with or without use of a corresponding support member 50). The plate 30 is mounted to the post 14 in the same way as described above and shown in FIGS. 1 through 8.

In FIG. 9, the support member 50 is shown as a pair of brackets 50 each of which defines a substantially “L”-shaped transverse cross-section and a length substantially equal to that of the mailbox 12. More specifically, the brackets 50 are shown substantially identical to, spaced from, and parallel with each other and located on a substantially central area of the upper surface 34 of the plate 30. The brackets 50 are shown also located in a substantially symmetrical manner vis-à-vis the upper surface 34. The mailbox 12 is shown without the flanges 18 such that a lower portion of each side of the mailbox 12 is adapted to be fastened to a “vertical” portion 52 of the corresponding bracket 50, the exterior of this lower portion is disposed substantially flush against the “vertical” portion 52, and the bottom edge of the side of the mailbox 12 rests upon or is fastened to a “horizontal” portion 54 of the bracket 50 in a substantially flush manner. However, in the event that the mailbox 12 includes the flanges 18, each flange 18 is adapted to be fastened to the “vertical” portion 52 such that the “vertical” portion 52 is disposed substantially flush against the flange 18 to the inside or outside of the flange 18 (in the latter case, the bottom edge of the flange 18 rests upon or is fastened to the “horizontal” portion 54 in a substantially flush manner).

It should be appreciated by those having ordinary skill in the related art that the support member 50 can have any suitable shape, size, and structure and structural relationship with the mailbox and 12 and plate 30. It should be so appreciated also that the support member 50 can be any suitable type of support member. It should be so appreciated also that the support member 50 can be attached to the plate 30 and fastened to the mailbox 12 in any suitable manner—such as by bolts, nails, screws, and/or the like. It should be so appreciated also that the system 10 can include any suitable number of support members 50. It should be so appreciated also that the system 10 can include no support member 50 such that the mailbox 12 and other mailbox(es) are mounted to the plate 30 in any suitable manner—such as by bolts, nails, screws, and/or the like.

It should be appreciated by those having ordinary skill in the related art that the system 10, in general, and each of the plate 30, sleeve 36, and support member 50 of the system 10, in particular, can be made of any suitable material and by any suitable method.

In operation, it is generally required that a local post office be contacted before the mailbox 12 is installed to ensure correct placement and height of the mailbox 12 in relation to a street. Generally speaking, though, the mailbox 12 should be installed such that there is a height of about 41 to 45 inches from a surface defined by the street (and into which the post 14 is installed) to a floor (not shown) defined by an inside of the mailbox 12 and a door of the mailbox 12 is set back about 6 to 8 inches from an imaginary vertical plane defined by a front face of a curb or edge of the street. However, if the mailbox 12 is of a “locked” design, the mailbox 12 should be installed at a height of about 41 to 45 inches from the street surface to a point of entry of mail into the mailbox 12. Also, it is recommended that corners and edges of the top portion 20 of the post 14 be rounded.

If the post 14 already exists, the mailbox 12 is, say, screwed to the system 10 with the door of the mailbox 12 open. Then, the sleeve 36 is placed about or into the post 14 by pressing firmly downward on the mailbox 12 and/or system 10 until the top portion 20 of the post 14 is securely fitted to the sleeve 36.

To mount multiple mailboxes 12 to the post 14, a mailbox 12 is placed on the upper surface 34 of the plate 30 with the door of the mailbox 12 open such that the mailbox 12 extends substantially transversely with respect to the plate 30 and a sufficient amount of space is defined to at least one side of the mailbox 12 for at least another mailbox to be supported by the plate 30. Then, the support member 50 is aligned with respect to the mailbox 12 and upper surface 34, and the upper surface 34 is marked for placement of the support member 50 on the upper surface 34. Then, the support member 50 is attached to the plate 30 and fastened to the flanges 18 of the mailbox 12. Each of the other mailboxes 12 is fastened to the system 10 in the same way. Then, the sleeve 36 is placed about or into the post 14 by pressing firmly downward on the mailbox 12 and/or system 10 until the top portion 20 of the post 14 is securely fitted to the sleeve 36.

To remove the system 10 and, in turn, mailbox 12 (or mailboxes 12 in the case of use of the support member 50) from the post 14, portions of the bottom of the system 10 (the plate 30 or sleeve 36) located closest to each side of the post 14 are gently tapped with, say, a hammer until the system 10 is loosened. Then, the system 10 and, in turn, mailbox 12 are manually pulled off the post 14. In this way, the mailbox 12 can be easily and quickly removed from the post 14 when, say, the mailbox 12 will not be used for a substantial period of time [e.g., owner(s) of the mailbox 12 will be vacationing out of town] or there is sufficient notice of impending natural occurrences—such as fire and/or heavy ice, rain, snow, and/or wind—that could damage the mailbox 12. Then, the system 10 and mailbox 12 can be placed in a safe environment, such as inside a garage or house, until it is safe to re-install the mailbox 12 to the post 14 by slipping the system 10 over the post 14 or the post 14 over the system 10. Therefore, use of the system 10 can eliminate damage and, thus, a need to make any repairs to the mailbox 12.

It should be appreciated by those having ordinary skill in the related art that the mailbox 12 can be installed at any suitable height above the street surface. It should be so appreciated also that the surface into which the post 14 is installed can be any suitable surface. It should be so appreciated also that the mailbox 12 can be set back any suitable distance from the street. It should be so appreciated also that the mailbox 12 and system 10 can be secured to each other in any suitable manner. It should be so appreciated also that the post 14 and system 10 can be securely fitted to each other in any suitable manner.

The system 10 can be used to conveniently, easily, efficiently, and safely install the mailbox 12 to the post 14. And, use of the system 10 can eliminate damage and, thus, a need to make any repairs to the mailbox 12. More specifically, the system 10 can be easily and quickly removed from the post 14 when there is sufficient notice of impending natural occurrences—such as fire and/or heavy ice, rain, snow, and/or wind—that could damage the mailbox 12. Furthermore, in the event that the mailbox 12 needs to be repaired, use of the system 10 eliminates repairing of the mailbox 12 in or adjacent to vehicular traffic. More specifically, use of the system 10 allows for repair of the mailbox 12 in a safe environment, such as inside a garage or house. In addition, the system 10 can be used with an existing post and even if a new post is needed. Moreover, the system 10 is one-piece. Plus, the system 10 can be used by the general population. A single system 10 can install multiple mailboxes 12 to the post 14 as well.

The system 10 has been described above in an illustrative manner. It is to be understood that the terminology that has been used above is intended to be in the nature of words of description rather than of limitation. Many modifications and variations of the system 10 are possible in light of the above teachings. Therefore, within the scope of the appended claims, the system 10 may be practiced other than as specifically described above and shown in the figures.

What is claimed is:

1. A system for mounting a mailbox to an upstanding post defining a closed-ended upper portion of the post, said system comprising:
a plate adapted to mount the mailbox and defining a lower surface and an upper surface of said plate, said upper surface being adapted to support a lower surface of the mailbox; and
a sleeve extending downwardly from said lower surface of said plate, adapted to matingly receive the upper portion of the post, and defining at least one interior wall of said sleeve, wherein said interior wall defines at least one rib of said interior wall adapted to contact an exterior surface of the upper portion of the post to fittingly secure the post within said sleeve and, thus, mount the mailbox to the post.

2. The mailbox-mounting system as set forth in claim 1, wherein each of said lower and upper surfaces of said plate is substantially planar.

3. The mailbox-mounting system as set forth in claim 2, wherein said upper surface of said plate is substantially coplanar with the lower surface of the mailbox.

4. The mailbox-mounting system as set forth in claim 1, wherein said plate defines a rim that depends from and at least partially outlines said lower surface of said plate and, in combination with said lower surface of said plate, defines an interior of said plate in which an array of a plurality of ribs is disposed, respective portions of said array being attached to said rim, sleeve, and lower surface of said plate to provide structural integrity to said system.

5. The mailbox-mounting system as set forth in claim 4, wherein said rim of said plate is substantially uniform, integrally depends from and completely outlines said lower surface of said plate, and defines a bottom edge of said rim that is disposed substantially flush with respect to a bottom edge defined by said array of ribs.

6. The mailbox-mounting system as set forth in claim 4, wherein a portion of the mailbox is adapted to interferingly fit about at least a portion of said rim of said plate to mount said plate to the mailbox.

7. The mailbox-mounting system as set forth in claim 1, wherein said plate defines a length and width of said plate that are greater than a corresponding length and width defined by said sleeve and said plate defines a height of said plate that is lesser than a height defined by said sleeve.

8. The mailbox-mounting system as set forth in claim 1, wherein said sleeve integrally extends downwardly from a substantially central portion of said lower surface of said plate.

9. The mailbox-mounting system as set forth in claim 1, wherein said sleeve defines a plurality of interior walls of said sleeve each of which defines a plurality of ribs of said interior wall adapted to contact the exterior surface of the upper portion of the post to fittingly secure the post within said sleeve.

10. The mailbox-mounting system as set forth in claim 1, wherein said system comprises further a support member attached to said plate and adapted to support the lower surface of the mailbox such that the mailbox extends substantially transversely with respect to said plate and a sufficient amount of space is defined to at least one side of the mailbox for at least another mailbox to be supported by said plate.

11. A system for mounting a mailbox to an upstanding post defining an open-ended upper portion of the post, said system comprising:
a plate adapted to mount the mailbox and defining a lower surface and an upper surface of said plate, said upper surface being adapted to support a lower surface of the mailbox; and
a sleeve extending downwardly from said lower surface of said plate, adapted to be matingly received by the upper portion of the post, and defining at least one exterior wall of said sleeve, wherein said exterior wall defines at least one rib of said exterior wall adapted to contact an interior surface of the upper portion of the post to fittingly secure said sleeve within the post and, thus, mount the mailbox to the post.

12. The mailbox-mounting system as set forth in claim 11, wherein each of said lower and upper surfaces of said plate is substantially planar.

13. The mailbox-mounting system as set forth in claim 12, wherein said upper surface of said plate is substantially coplanar with the lower surface of the mailbox.

14. The mailbox-mounting system as set forth in claim 11, wherein said plate defines a rim that depends from and at least partially outlines said lower surface of said plate and, in combination with said lower surface of said plate, defines an interior of said plate in which an array of a plurality of ribs is disposed, respective portions of said array being attached to said rim, sleeve, and lower surface of said plate to provide structural integrity to said system.

15. The mailbox-mounting system as set forth in claim 14, wherein said rim of said plate is substantially uniform, integrally depends from and completely outlines said lower surface of said plate, and defines a bottom edge of said rim that is disposed substantially flush with respect to a bottom edge defined by said array of ribs.

16. The mailbox-mounting system as set forth in claim 14, wherein a portion of the mailbox is adapted to interferingly fit about at least a portion of said rim of said plate to mount said plate to the mailbox.

17. The mailbox-mounting system as set forth in claim 11, wherein said plate defines a length and width of said plate that are greater than a corresponding length and width defined by said sleeve and said plate defines a height of said plate that is lesser than a height defined by said sleeve.

18. The mailbox-mounting system as set forth in claim 11, wherein said sleeve integrally extends downwardly from a substantially central portion of said lower surface of said plate.

19. The mailbox-mounting system as set forth in claim 11, wherein said sleeve defines a plurality of exterior walls of said sleeve each of which defines a plurality of ribs of said exterior wall adapted to contact the interior surface of the upper portion of the post to fittingly secure said sleeve within the post.

20. The mailbox-mounting system as set forth in claim 11, wherein said system comprises further a support member attached to said plate and adapted to support the lower surface of the mailbox such that the mailbox extends substantially transversely with respect to said plate and a sufficient amount of space is defined to at least one side of the mailbox for at least another mailbox to be supported by said plate.
